(19) United States
(12) Patent Application Publication
(10) Pub. No.: US 2013/0213942 A1
(43) Pub. Date: Aug. 22, 2013

(54) METHOD AND SYSTEM FOR LASER WELDING AND CLADDING WITH MULTIPLE CONSUMABLES

(71) Applicant: Lincoln Global, Inc., (US)

(72) Inventors: Steven R. PETERS, Huntsburg, OH (US); Paul E. Denney, Bay Village, OH (US); George D. Blankenship, Chardon, OH (US)

(73) Assignee: Lincoln Global, Inc., City of Industry, CA (US)

(21) Appl. No.: 13/849,860

(22) Filed: Mar. 25, 2013

Related U.S. Application Data
(63) Continuation-in-part of application No. 13/212,025, filed on Aug. 17, 2011.
Application No. 13/212,025 is a continuation-in-part of application No. 12/352,667, filed on Jan. 13, 2009.

(51) Int. Cl. B23K 9/04; B23K 26/34

(52) U.S. Cl. CPC B23K 9/042; B23K 26/345
USPC 219/76.1; 219/121.65

(57) ABSTRACT

A system and method to provide a welding or cladding operation is provided which using multiple consumables in a single operation, where the overall heat input is reduced. Each of the consumables can be deposited into a single molten puddle, where the total energy input to the puddle from trailing consumables is less than that of a leading consumable. Further embodiments can use more than one molten puddle, but the energy input by the leading consumable is still higher than that of trailing consumables.

### PRIORITY CLAIM

The present application is a continuation-in-part of U.S. patent application Ser. No. 13/212,025, filed on Aug. 17, 2011, which is a continuation-in-part of U.S. patent application Ser. No. 12/352,667, filed on Jan. 13, 2009, both of which are incorporated herein by reference in their entirety, and a continuation of U.S. patent application Ser. No. 13/547,649, filed on Jul. 12, 2012, which is incorporated herein by reference in its entirety.

### TECHNICAL FIELD

This invention relates to a systems and methods for hot wire welding and cladding. More specifically, the subject invention relates to systems and methods for using multiple hot wire consumables for welding or cladding a work piece.

### BACKGROUND

Many different systems and methodologies have been used to perform welding, cladding or surfacing operations on a work piece, but these methodologies have limitations. For example, arc welding systems can provide relative good deposition rates but provide a very high heat input with a relatively thick build up and high admixture. Electroslag strip systems can also be used and provide decreased admixture levels, but these systems also have a relatively high amount of heat input and thickness. Some laser systems have been developed to provide cladding on a work piece but these laser systems have limited deposition rates and deposition width.

Further limitations and disadvantages of conventional, traditional, and proposed approaches will become apparent to one of skill in the art, through comparison of such approaches with embodiments of the present invention as set forth in the remainder of the present application with reference to the drawings.

### SUMMARY

Embodiments of the present invention include methods and systems to provide improved deposition rates for cladding and surfacing operations, where multiple hot wire consumables are provided to a single puddle on the surface of the work piece, and where the power or energy input to the puddle is highest at the leading consumable(s) than the power or energy input at the trailing consumables.

These and other features of the claimed invention, as well as details of illustrated embodiments thereof, will be more fully understood from the following description and drawings.

### BRIEF DESCRIPTION OF THE DRAWINGS

The above and/or other aspects of the invention will be more apparent by describing in detail exemplary embodiments of the invention with reference to the accompanying drawings, in which:

FIG. 1 is a diagrammatical representation of a system in accordance with an exemplary embodiment of the present invention;

FIG. 2 is a diagrammatical representation of a cladding/welding operation in accordance with an exemplary embodiment of the present invention;

FIG. 2A is a diagrammatical representation of an interaction zone between a consumable and a puddle.

FIGS. 3A and 3D are diagrammatical representations of additional welding/cladding operations of the present invention;

FIG. 4 is a diagrammatical representation of a consumable delivery head in accordance with an exemplary embodiment of the present invention;

FIG. 5 is a diagrammatical representation of an additional welding/cladding operation in accordance with an exemplary embodiment of the present invention;

FIG. 6 is a diagrammatical representation of a further exemplary embodiment of the present invention;

FIG. 7 is a diagrammatical representation of another exemplary system of the present invention;

FIGS. 8A and 8B are diagrammatical representations of a further exemplary embodiment of a cladding operation of the present invention.

### DETAILED DESCRIPTION

Exemplary embodiments of the invention will now be described below by reference to the attached Figures. The described exemplary embodiments are intended to assist the understanding of the invention, and are not intended to limit the scope of the invention in any way. Like reference numerals refer to like elements throughout.

As each of U.S. applications Ser. Nos. 12/352,667, 13/212,025 and 13/547,649, which are incorporated by reference in their entirety, embodiments of the present invention, systems and methods described herein can be used for either overlaying or welding/joining applications. For purposes of simplicity the following discussion will reference cladding operations, but embodiments of the present invention are not limited in this way.

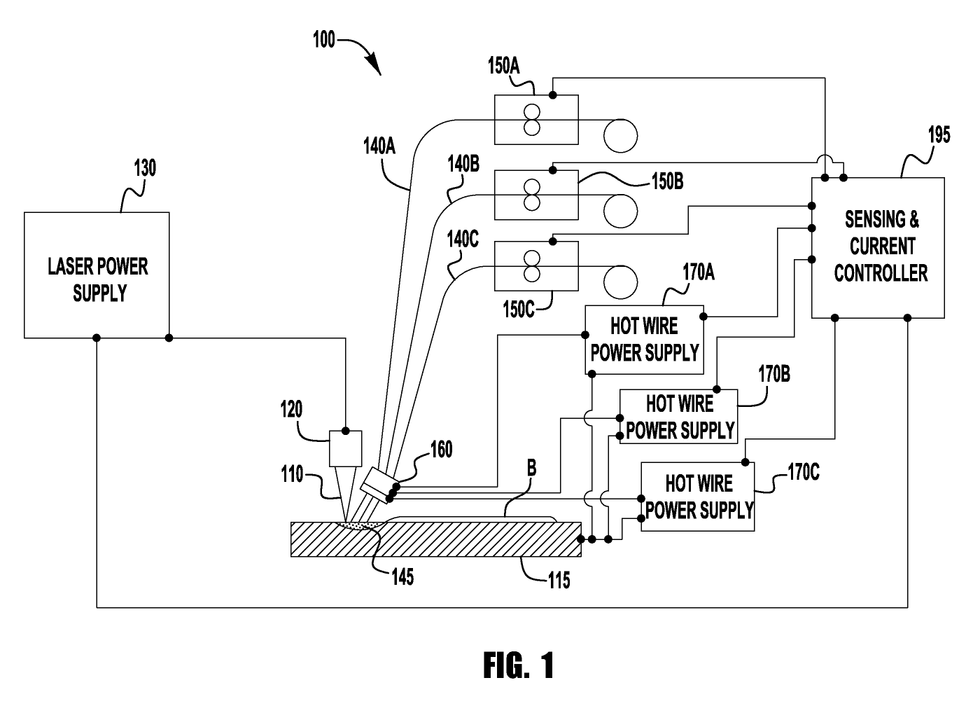

FIG. 1 is an illustrative representation of a system 100 that can be used with embodiments of the present invention. The operation, components and control of the system 100 is generally described in related applications Ser. Nos. 12/352,667, 13/212,025 and 13/547,649 (incorporated herein in their entirety), with the differences described herein.

As shown in FIG. 1, the system 100 delivers a plurality of consumables 140A through 140C to a puddle 145 during the operation. The puddle 145 is created by a high energy heat source, such as a laser system (power supply 130, laser 120 and beam 110). The heat source melts the surface of the work piece 115 to the appropriate depth for the desired operation and creates the puddle with the desired shape and properties. In the embodiment shown only three consumables 140A-140C are being delivered to the puddle 145, but embodiments of the present invention are not limited in this regard as more than three consumables can be used. Each of the consumables 140A-140C are delivered to the puddle 145 via a contact assembly 160 and their respective wire feeders 150A, 150B and 150C, respectively. The wire feeders 150A to 150C can have any known wire feeder construction and can be dual-type wire feeders which are capable of delivering more than one consumable to the puddle 145. That is, a single wire feeder device can be used that is capable of providing multiple consumables to a single operation. Each of the wire feeders 150A to 150C can be controlled by the controller 195 as described herein and/or as described in the incorporated priority applications.

Also, as shown in FIG. 1, the exemplary system 100 utilizes a plurality of hot wire power supplies 170A, 170B and 170C which are coupled to the contact assembly 160 to deliver heating currents to the respective consumables 140A through 140C. Further discussion of the assembly 160 will be set forth below. The heating currents from the power supplies 170A, 170B and 170C are utilized to melt the consumables in the puddle 145 such that the consumables 140A-140C are completely melted in the puddle 145. However, the heating currents from the power supplies 170A-170C are controlled such that arcing events between the consumables 140A-140C and the work piece 115 are avoided or minimized. The control of the heating currents is described in detail in the incorporated applications and will not be repeated herein.

In exemplary embodiments of the present invention, each of the consumables 140A to 140C are delivered to the puddle 145 at the same wire feed speed. However in other embodiments, as explained further below, the respective wire feed speeds of the consumables 140A to 140C can vary.

It should be noted that a number of connections between the components shown in FIG. 1, for example any current and voltage detection connections for the power supplies 170A through 170C are not shown in this figure for clarity. However, it is well understood to provide current and/or voltage

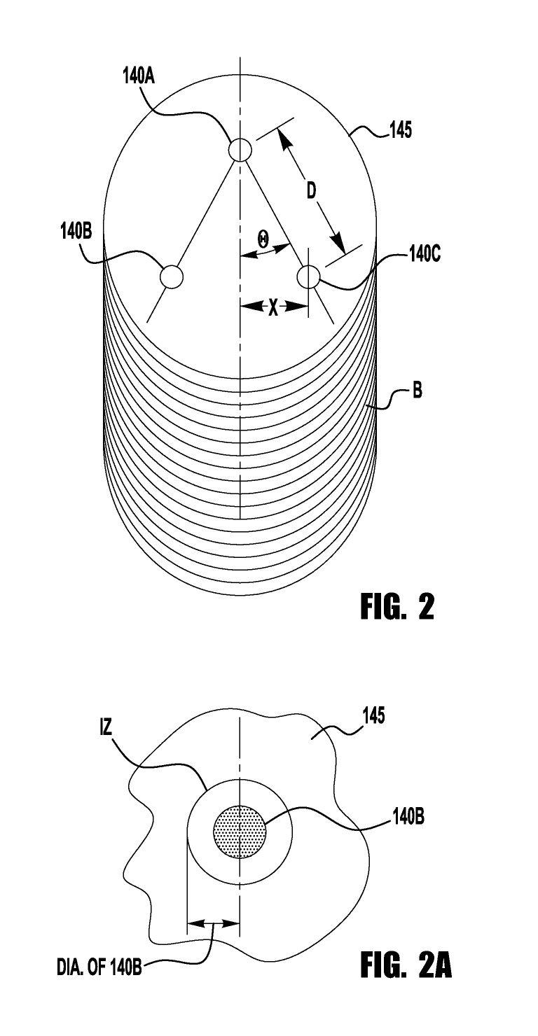

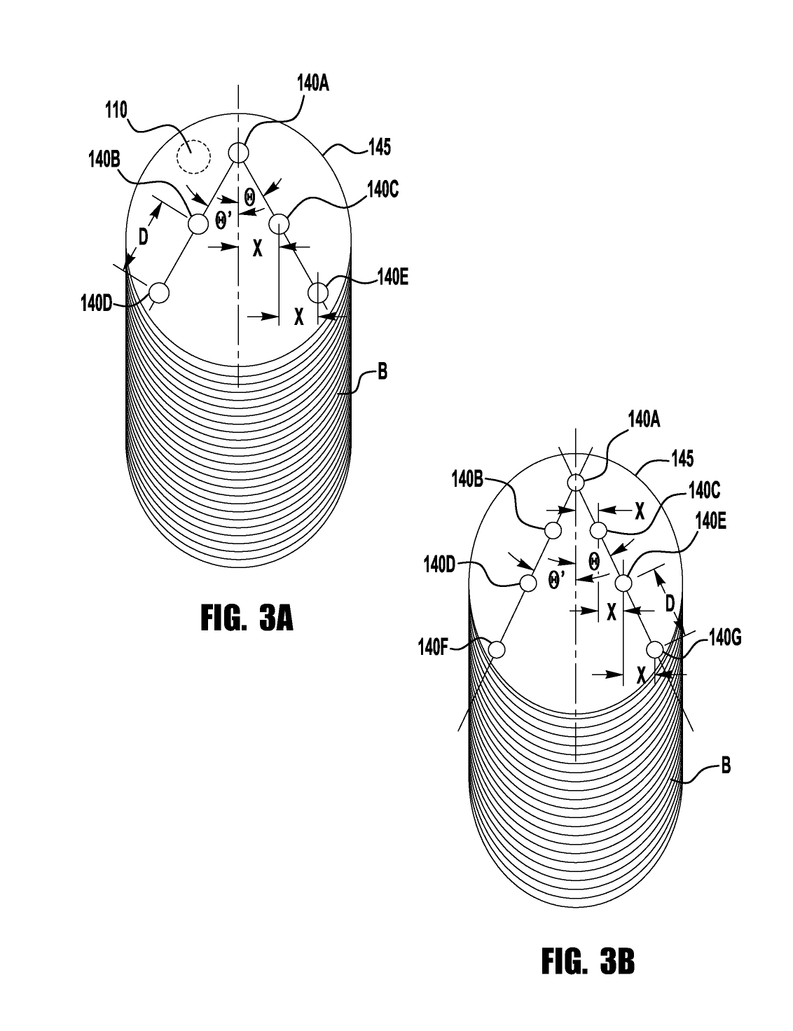

FIG. 2 depicts an exemplary embodiment of a cladding operation as implemented by the system 100. As shown, each of the plurality of consumables 140A to 140C are directed to the same puddle 145 and are arranged in a “V” formation such that the consumable 140A leads each of the consumables 140B and 140C in the travel direction. As shown each of the trailing consumables 140B and 140C are positioned off the centerline of the lead consumable 140A (in the travel direction) by an angle θ. In exemplary embodiments of the present invention, the angle θ is in the range of 10 to 75 degrees. In other exemplary embodiments, the angle can be as low as 0 degrees—which would have the consumables trailing in a line, and in other embodiments the angle could be as large as 90 degrees such that the wires are in a line normal to the travel direction of the operation. In such an embodiment the required heat input may be increased but such an embodiment can provide maximum width for the bead during an operation. Additionally, the trailing consumables 140B and 140C are positioned such that they are a distance D from the lead consumable 140A, where the distance D is in the range of 1.5 to 5 times the diameter of the leading consumable. In other exemplary embodiments, the distance D will be in the range of 2 to 4 times the diameter of the leading consumable. In exemplary embodiments, a number of factors will affect determining a desired distance D, including: wire diameters, wire feed rates, travel speed, wetting and response of the workpiece material, laser beam geometry and energy input, among other factors. Further, the trailing consumables 140B/C are positioned outward (relative to the travel direction) from the centerline of the preceding consumable 140A by a distance X, where the distance X is in the range of 1 to 8 times the diameter of the respective trailing consumable (e.g., 140C in FIG. 2). In further exemplary embodiments, the distance X from the centerline is in the range of 1.5 to 5 times the diameter of the respective trailing consumable. It should be noted that the distance X as discussed herein for the respective trailing consumable is measured from the centerline of its preceding consumable, which may or may not be the lead consumable (140A). For example, see FIG. 3A. As stated above regarding the distance D, numerous factors can contribute to the determination of the distance X, including those referenced above regarding the distance D. Further, in optimizing both distances X and D, to the extent a laser beam is used to heat the puddle, the optics and overall size/shape of the beam should also be taken into account such that all of the wires are positioned within the impact area of the beam as it projects on the surface of the workpiece. Further, spacing should be determined to ensure an acceptable bead surface on the workpiece.

As discussed above, and further herein, the embodiments shown in FIG. 2 shows that each of the consumables 140A to 140C are in the same molten puddle 145. However, in other exemplary embodiments this may not be the case as there will be a separate puddle for each consumable 140A to 140C which would aid in minimizing heat input into the weld, as it is not necessary to keep the intermediate areas between the consumable puddles in a molten state. However, in such embodiments the intermediate areas can be either solid or in a semi-molten state in between the respective puddles. Thus, in referring to FIG. 2, the leading consumable 140A would be deposited into its own puddle and at least one of the trailing consumables 140B and/or 140C would be deposited in their own puddle. In such an embodiment, the region between a leading consumable molten puddle and a trailing consumable molten puddle is in a non-molten state (semi-molten or solid), rather than having one large puddle for all consumables. In such exemplary embodiments of the present invention, the non-molten region between the respective puddles can have an average temperature in the range of 35 to 90% of the temperature of the leading molten puddle. In other exemplary embodiments, the non-molten region between the respective puddles can have an average temperature in the range of 50 to 85% of the temperature of the leading molten puddle. Thus, in such embodiments each of the consumables 140A to 140C is deposited into their own respective puddles, where the temperature of the workpiece between the respective puddles results in the workpiece having a non-molten state. As an example, the leading consumable would be 140A in FIG. 2, but would be 140D (as compared to 140F) in FIG. 3B. In other exemplary embodiments, at least two of the consumables in a formation are in the same molten puddle, while others are not and are separated from the common puddle as described above. Such embodiments aid in reducing the overall heat input from the operation. It should be understood that the region between respective puddles can be generally described by the region defined by the boundaries of the respective puddles and lines from the outer edges of one puddle to the outer edges of the other puddle. In other exemplary embodiments of the present invention, while separate puddles are utilized there may be more than one consumable deposited into a single puddle. For example, referring to FIG. 2, the leading consumable 140A can be deposited into its own separate puddle, while both trailing consumables 140B and 140C are deposited into a single puddle.

When using a consumable distribution as described above an increased consumable deposition rate while maintaining a relatively thin layer—when cladding. Further, the overall energy input into the process is reduced as compared to known systems and methods. Specifically, because each of the consumables 140A, 140B and 140C are deposited into the same puddle 145 during the operation, the overall power input into the puddle 145 can be minimized. This is because the energy utilized to initially create the puddle and deposit the leading consumable 140A preheats the area surrounding the puddle 145 around the leading consumable 140A, which means that the energy needed to melt the trailing consumables 140B and 140C fully into the puddle 145 is not as much as the need to initiate the puddle 145 and fully consume the leading consumable 140A, assuming the consumables are similar in chemistry and size. Stated differently, the residual heating from the leading interaction zone aids in pre-heating the interaction zones for the trailing consumables, and thus lower the amount of energy required to heat the trailing consumables in their respective interaction zones. As generally understood, the energy required to heat a material is generally linear until a phase or structure change occurs in the material. For example, when a solid becomes liquid. When such a transformation occurs, some materials require a non-linear increase in energy to transform the material from one state to the other. After the phase change in the material, again the energy needed to increase the material temperature becomes linear. Similarly, as a material (like metal) cools the energy dissipation is linear until it approaches and reaches the phase change (cooling from liquid to solid), and at this point the material gives up energy to transfer to the new phase, and this energy dissipation is, again, non linear until the chase change is completed. Embodiments of the present invention take advantage of these energy characteristics and allow for a reduced overall energy input while achieving a high deposition rate, minimal admixture and relatively thinning coating during cladding processes. Thus, embodiments of the present invention provide significant advantages over known cladding and joining processes.

In the embodiment shown in FIG. 2 the consumables 140A, 140B and 140C are distributed symmetrically along the centerline of the lead consumable 140A. However, embodiments of the present invention are not limited in this regard as the positioning of the trailing consumables can be asymmetrical with respect to the leading consumable 140A centerline. For example, one of the trailing consumables 140B can be positioned at a first angle in the range of 10 to 75 degrees, while the other 140C is at a second angle (different from the first) in the range of 10 to 75 degrees. Additionally, in other exemplary embodiments, the distances D for the respective trail consumables 140B and 140C are different from each other. The positioning of the consumables can be determined and optimized based on the desired deposition of the consumable.

FIGS. 3A through 3D depict additional exemplary embodiments of the present invention. FIG. 3A depicts a similar embodiment to that shown in FIG. 2 except that five consumables 140A through 140E are utilized. FIG. 3B is another similar embodiment which uses seven consumables 140A to 140G in a similar configuration to that shown in FIGS. 2 and 3A. Again, the embodiments shown in each of these figures can have symmetrical or non-symmetrical configurations.

Additionally, as described above, the energy input into the puddle 145 at the interaction zones for each of the trailing consumables 140B through 140G is less than the energy input into the puddle 145 at the leading consumable 140A interaction zone. In general, the interaction zone of a consumable is the area of the puddle 145 around the consumable which is immediately affected by the consumable as it enters the puddle 145, from both a metallurgical and heat input stand point. A diagrammatical representation of this can be found in FIG. 2A, where the interaction zone IZ is shown around the consumable 140B. Many factors can affect the size and shape of the interaction zone IZ, but typically an interaction zone IZ can be represented by a circular area having a radius that is approximately the same as the diameter of the consumable 140B, and is centered on the centerline of the respective consumable. It should be noted that in many instances the interaction zone IZ may not be circular in shape, but rather have an elliptical shape with the long axis of the ellipse parallel to the travel direction of the operation. With that said, in many cases an appropriate approximation of the zone IZ is as stated above. In some exemplary embodiments, the energy input at each of the trailing interaction zones is the same. In other exemplary embodiments, the energy input at the trailing interaction zones can vary. For example, in some exemplary embodiments the first row of trailing consumables 140B and 140C each have a first energy input into their respective interaction zones which is less than that of the lead consumable 140A energy input, but the energy input at 140B and 140C is higher than the energy input in the interaction zones of the consumables 140D and 140E which are trailing 140B and 140C. In other exemplary embodiments, the energy input at the middle consumables 140B and 140C is less than that at the leading consumable 140A and less than that at the trailing consumables 140D and 140E. Further, while in some exemplary embodiments the energy input at adjacent consumables (e.g., 140B and 140C, or 140D and 140E) is the same, while in other exemplary embodiments the relative energy input can vary.

It is understood that the energy input into a respective zone can come from a number of sources to maintain the puddle 145 and ensure proper melting of the consumables. In the embodiments described herein, energy input comes from the heating current used to heat the consumables 140A-140G from their respective power supplies. Additionally, the high energy heat source (for example, the laser 120 and beam 110) can be used to add additional heat input. In the system shown in FIG. 1 the laser 120 can direct the beam to create the puddle and maintain the desired energy input in the leading interaction zone for consumable 140A. However, in other exemplary embodiments, the laser 120 can also direct the beam 110 to any number or all of the trailing interaction zones to provide the desired energy input to maintain the puddle 145 and melt the trailing consumables.

FIG. 3C depicts an exemplary embodiment of the invention where the laser spot LS is translated around the leading edge of the puddle 145 to create the puddle 145 and provide the necessary energy to melt the consumables. The pattern, spot latency, and energy can be varied as desired to achieve the desired puddle shape and energy input. Also, as shown in FIG. 3C (and discussed above) the angles θ and θ′ can either be the same, or can be different depending on the desired operational parameters.

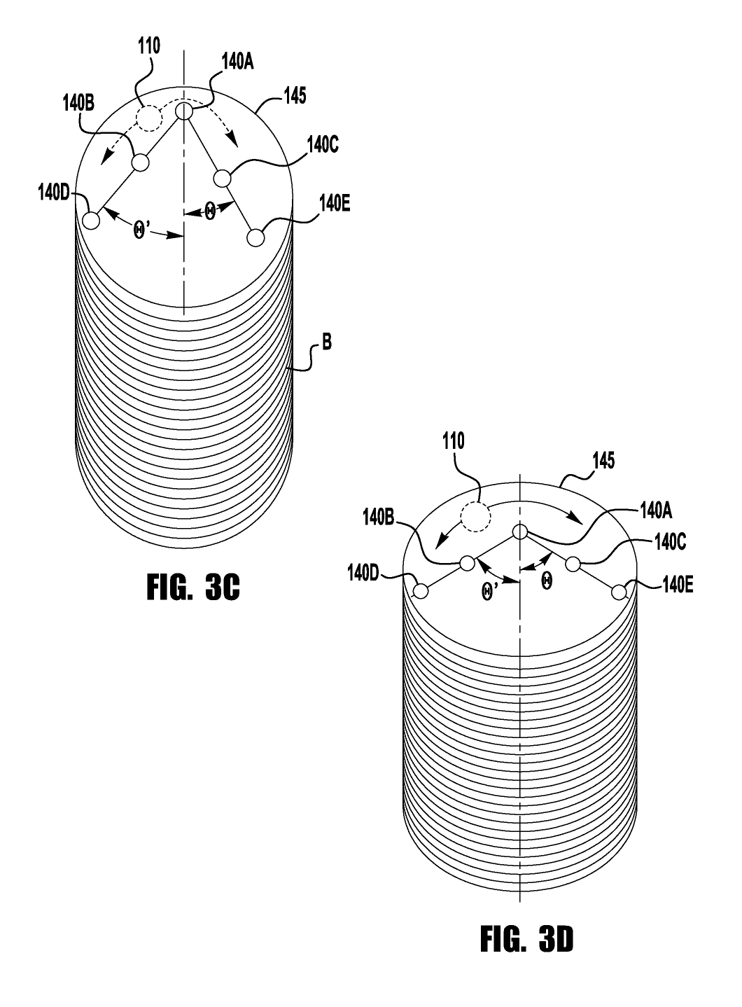

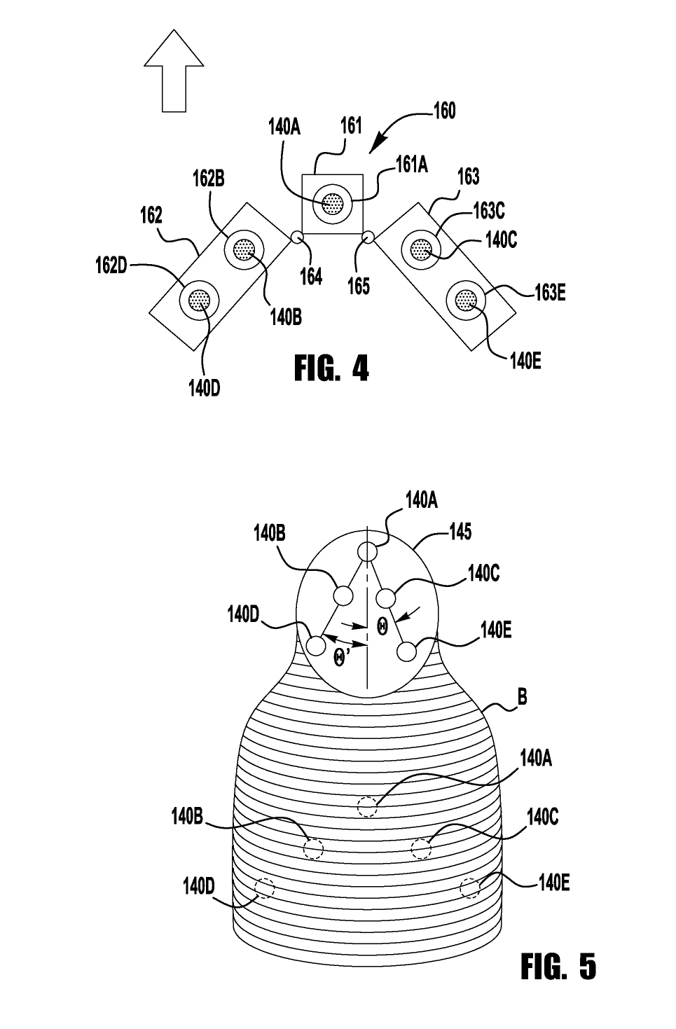

In some exemplary embodiments of the present invention, the angles θ and θ′ can be varied during the operation. That is, during a cladding operation the angling of the trailing consumables can be varied to change the width and/or thickness of the cladding. FIG. 3D shows an embodiment where the trailing consumables 140B-E have been angled out such that the width of the puddle 145 and deposited material is increased. FIG. 4 depicts an exemplary embodiment of a contact assembly 160 that may be used with embodiments of the present invention. The assembly 160 comprises at least a lead section 161, a first angled section 162 and a second angled section 163. The lead section contains a contact tip 161A for the lead consumable 140A, the first angled section 162 contains contact tips 162B and 162D, while the second section 163 contains the contact tips 163C and 163E. The contact tips are used to deliver the heating current to each of the respective consumables so that they can be melted in the puddle 145. In exemplary embodiments of the present invention, the assembly 160 and sections 161, 162 and 163 are constructed such that each of the contact tips are electrically isolated from each other. Also, in the embodiment shown in FIG. 4, the assembly contains pivot components 164 and 165 which allow each of the sections 162 and 163 to be pivotably engaged with the lead section 161. The pivot components 164 and 165 can be any type of joint which will allow the sections 162 and 163 to move in at least one plane to allow the positioning of at least some of the trailing consumables to be repositioned (for example, a hinge). Such embodiments allow at least some, or all, of the trailing consumables 140B-140E to be repositionable either during or prior to an operation. By allowing for the repositioning of at least some of the trailing consumables embodiments of the present invention to be movable the deposition width and/or thickness of a cladding layer (or other deposition) to be varied. An embodiment of this is shown in FIG. 5, where the sections 162 and 163 are moved during the operation to change the width of the bead B. The sections 162 and/or 163 can be moved by any mechanical means, such as actuators or motors that can be controlled by the controller 195. Optionally, the sections can be positioned manually before an operation begins.

During certain operations it may be desirable to change the width of the bead B without changing the depth of the bead B (for example maintaining a cladding layer thickness). In such embodiments, the controller 195 can cause the sections 162 and 163 to be moved while changing the wire feed speed of one or more of the consumables 140B through 140E. For example, if the sections 162 and 163 are moved such that the bead is to be narrower, the wire feed speed of the consumables 140B through 140E can be slowed down to maintain a thickness. Further, the controller 195 can also modify the heating current to the consumables 140B through 140E to maintain the desired thickness.

In other exemplary embodiments of the present invention, the width and/or thickness of the bead B can be controlled through changes in the feeding of the consumables, without the need for moving the sections 162 and 163. For example, the controller 195 can cause the wire feeders for at least one of the consumables 140D and 140E to be stopped for a duration of the operation, thus resulting in a narrowing of the created bead B. Thus, embodiments of the present invention can control bead with and thickness through controlling the relative speeds of the consumables and/or turning the feeding of the consumables off or on.

It should be noted that in some exemplary embodiments of the present invention, the consumables utilized (e.g., 140A through 140E can have different chemistries to achieve a desired chemistry for the resultant bead B. Similar, the sizes (e.g., diameters) of the consumables can be different as well to achieve desired properties. For example, in some exemplary embodiments the lead consumable 140A can have a diameter which is larger than each of the trailing consumables. In such an embodiment the energy input into the leading interaction will be higher than that for the trailing interaction zones.

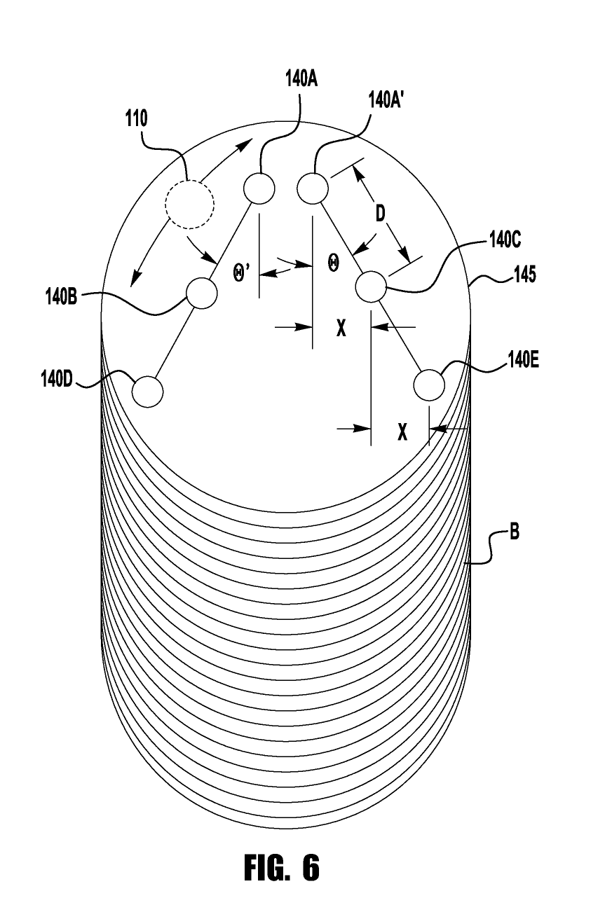

FIG. 6 depicts another exemplary embodiment of the present invention, where a tandem lead consumable configuration is used. In such an embodiment at least two consumables 140A and 140A′ are lead consumables which are adjacent to each other in the travel direction. Such an embodiment can provide increased bead width and bead thickness, without departing from the spirit or scope of the present invention.

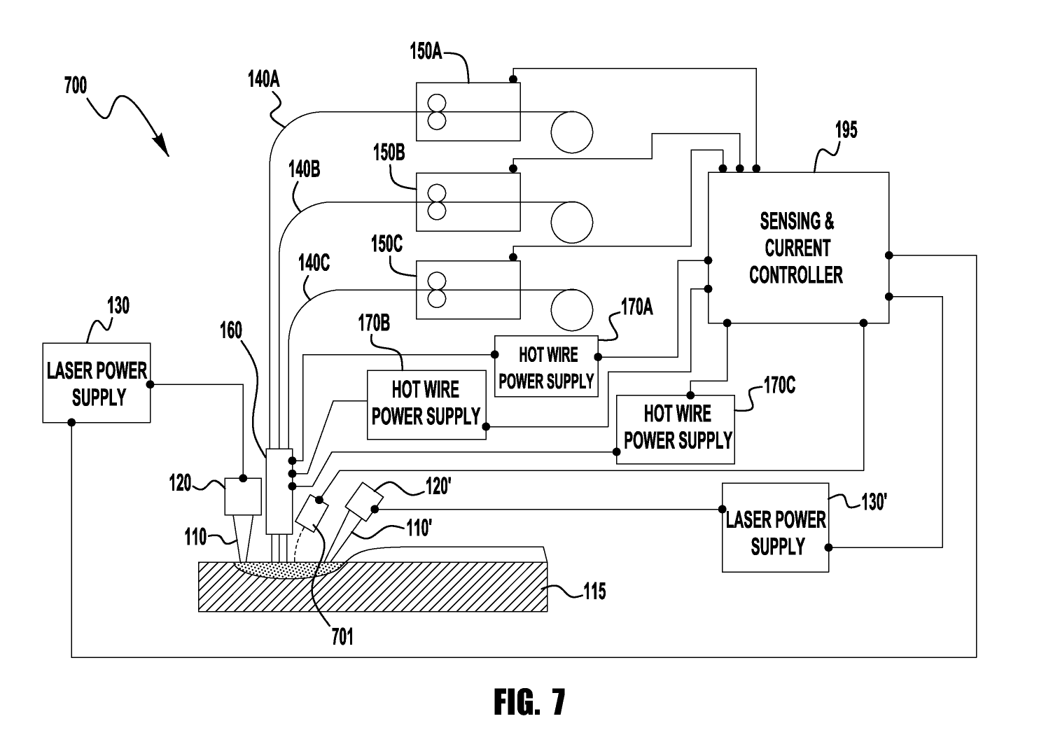

FIG. 7 depicts another exemplary embodiment of a system 700 similar to that shown in FIG. 1. The system 700 includes at least one sensor 701 which is coupled to the controller 195 which provides feedback related to the puddle 145. For example, in some exemplary embodiments the sensor 701 is a thermal sensor that detects a temperature of the puddle 145 at a desired location, which can include at least one of the consumable interaction zones. The controller 195 utilizes this feedback information to control the heat and/or energy input into the puddle 145 or to a particular consumable or interaction zone as needed to ensure proper puddle control and melting of the consumables in the puddle. Also, as shown in FIG. 7 the system can use an additional laser 120′ and beam 110′ to aid in the control of heat input into the interaction zones of the trailing consumables. Thus, the additional high energy heat source (e.g., laser 120′) can be controlled by the controller 195 to ensure that proper energy input is provided to each trailer interaction zone during the operation. For example, the controller can direct the beam 110′ to any one of the plurality of interaction zones that is sensed to be below a desired temperature and/or energy input. Such control can allow for optimal energy input during an operation, keeping the overall energy input into the puddle low for a very wide and thin bead B. Again, it should be noted that numerous connections (for example, voltage and current sensing for the power supplies 170A-170C) are not shown for clarity but are well understood.

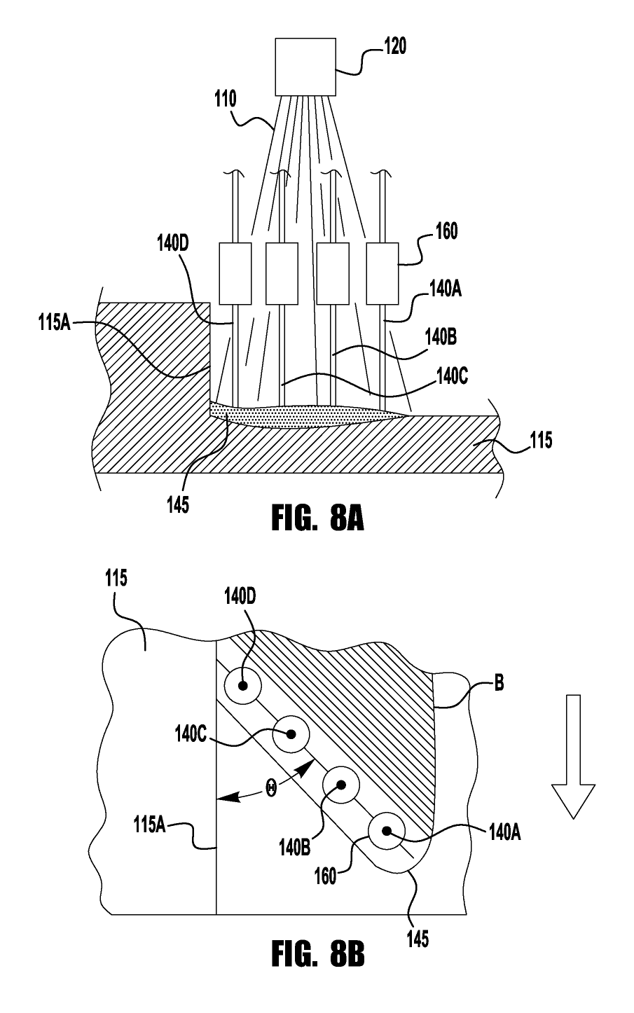

Another exemplary embodiment of the present invention is depicted in FIGS. 8A and 8B, where an angular consumable formation is shown, as opposed to the previously discussed “V” formation. In some cladding operations it may not be desirable to utilize a “V” type formation to the wires. For example, as shown in FIG. 8A, in some applications the cladding may have to butt up against a wall 115A. In such applications, the previously discussed wire formation might not be desirable, thus an angled configuration can be utilized as shown in FIGS. 8A and 8B, where the trailing wires 140B, 140C and 140D are trailing behind the lead wire 140A, but only to one side of the lead wire 140A. It should be noted that the above discussions about control, operation and spacing (dimensions X and D) equally apply to embodiments similar to that shown in FIGS. 8A and 8B, and therefore will not be repeated here.

In the embodiments shown the heat input in the lead wire 140A interaction zone will be higher than that in any of the trailing interaction zones. Further, the wires are aligned such that they have an angle of attack θ relative to the travel direction. In exemplary embodiments of the present invention, the angle of attack θ is in the range of 25 to 75 degrees. Of course, in other embodiments the angle can vary as needed. Further, similar to that discussed above, in some exemplary embodiments the angle of attack θ can change during the cladding operation based on the desired bead shape and pattern. For example, it may be desired to clad around a corner or at least change direction while cladding. In such embodiments, the assembly 160 can be turned, changing the angle of attack, and thus allowing the cladding operation to change directions.

It should be also be noted that in the embodiments shown in FIG. 8B depict that the consumable 140D closest to the wall 115A is the trailing consumable. However, in other embodiments this could be reversed such that the consumable 140D is the leading consumable and the consumable 140A is the trailing consumable. In such embodiments it may be desirable to have higher heat input at the wall 115A and in exemplary embodiments the highest heat input is at the leading consumable. Thus, in those embodiments the consumable 140D closest to the wall 115A is the leading consumable.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the appended claims.

We claim:

1. A method of cladding, comprising:
directing at least one laser beam at a surface of a workpiece to create a molten puddle;
advancing a plurality of consumables into said molten puddle so that said consumables will be deposited on said workpiece; and
applying a heating signal to each of said plurality of consumables to melt each of said consumables in said molten puddle;
wherein one of said plurality of consumables is a leading consumable and another of said consumables trails behind said leading consumable as a trailing consumable, in a travel direction, while said consumables are advancing into said molten puddle,
wherein each of said plurality of said consumables has a respective interaction zone in said molten puddle, and where a first amount of total energy is input into said puddle at said interaction zone for said leading consumable and a second amount of total energy is input into said puddle at said interaction zone for said trailing consumable, and
wherein said second amount of total energy is less than said first amount of total energy.

2. The method of claim 1, wherein said trailing consumable is a distance D from said leading consumable, where D is in the range of 1.5 to 5 times the diameter of said leading consumable, and a distance X off of the centerline of said leading consumable, where X is in the range of 1 to 8 times the diameter of the trailing consumable.

3. The method of claim 1, wherein said trailing consumable is a distance D from said leading consumable, where D is in the range of 2 to 4 times the diameter of said leading consumable, and a distance X off of the centerline of said leading consumable, where X is in the range of 1.5 to 5 times the diameter of the trailing consumable.

4. The method of claim 1, wherein the interactive zone of said leading consumable is represented by a circular area having a radius that is approximately the diameter of the leading consumable and centered on the centerline of the leading consumable, and wherein the interactive zone of said trailing consumable is represented by a circular area having a radius that is approximately the diameter of the trailing consumable and centered on the centerline of the trailing consumable.

5. The method of claim 1, wherein said trailing consumable is positioned at an angle in the range of 10 to 75 degrees off of the centerline of said leading consumable.

6. The method of claim 1, wherein said plurality of consumables includes a second trailing consumable which trails behind said leading consumable on an opposite side of a centerline of said leading consumable than said trailing consumable and is being advanced into said puddle, and said second trailing consumable has an interaction zone in said molten puddle and a third amount of total energy is input into said molten puddle at second trailing consumable interaction zone.

7. The method of claim 6, wherein said third amount of total energy is the same as the second amount of total energy.

8. The method of claim 6, wherein said second trailing consumable is positioned behind said leading consumable symmetrically with respect to said trailing consumable over a centerline of said leading consumable.

9. The method of claim 6, wherein each of said trailing consumable and second trailing consumable is positioned a distance D from said leading consumable, where D is in the range of 1.5 to 5 times the diameter of said leading consumable, and wherein said trailing consumable is positioned at a first angle off of the centerline of said leading consumable, and said second trailing consumable is positioned at a second angle off of said centerline, where said second angle is different from said first angle.

10. The method of claim 9, wherein at least one of said first and second angles is in the range of 10 to 75 degrees.

11. The method of claim 1, further comprising moving said trailing consumable with respect to said centerline during said advancing.

12. A method of cladding, comprising:
directing at least one laser beam at a surface of a workpiece to create a plurality of molten puddles;
advancing a plurality of consumables into said molten puddles so that said consumables will be deposited on said workpiece, where at least one of said plurality of consumables is directed to at least one of said molten puddles; and
applying a heating signal to each of said plurality of consumables to melt each of said consumables in said molten puddles;
wherein one of said plurality of consumables is a leading consumable and another of said consumables trails behind said leading consumable as a trailing consumable, in a travel direction, while said consumables are advancing into said molten puddles,
wherein each of said plurality of said consumables has a respective interaction zone in its respective molten puddle, and where a first amount of total energy is input into said molten puddle for said leading consumable at said leading consumable interaction zone and a second amount of total energy is input into said molten puddle for said trailing consumable at said trailing consumable interaction zone,
wherein said second amount of total energy is less than said first amount of total energy, and
wherein a region of said workpiece between said molten puddle for said leading consumable and said molten puddle for said trailing consumable is either in a solidified or semi-molten state.

13. The method of claim 12, wherein the temperature of said region is in the range of 35 to 90% of the temperature of said molten puddle for said leading consumable.

14. The method of claim 12, wherein wherein the temperature of said region is in the range of 50 to 85% of the temperature of said molten puddle for said leading consumable.

15. The method of claim 12, wherein said trailing consumable is a distance D from said leading consumable, where D is in the range of 1.5 to 5 times the diameter of said leading consumable, and a distance X off of the centerline of said leading consumable, where X is in the range of 1 to 8 times the diameter of the trailing consumable.

16. The method of claim 12, wherein said trailing consumable is a distance D from said leading consumable, where D is in the range of 2 to 4 times the diameter of said leading consumable, and a distance X off of the centerline of said leading consumable, where X is in the range of 1.5 to 5 times the diameter of the trailing consumable.

17. The method of claim 12, wherein the interactive zone of said leading consumable is represented by a circular area having a radius that is approximately the diameter of the leading consumable and centered on the centerline of the leading consumable, and wherein the interactive zone of said trailing consumable is represented by a circular area having a radius that is approximately the diameter of the trailing consumable and centered on the centerline of the trailing consumable.

18. The method of claim 12, wherein said trailing consumable is positioned at an angle in the range of 10 to 75 degrees off of the centerline of said leading consumable.

19. The method of claim 12, wherein said plurality of consumables includes a second trailing consumable which trails behind said leading consumable on an opposite side of a centerline of said leading consumable than said trailing consumable and is being advanced into an additional of said molten puddles, and said second trailing consumable has an interaction zone in said additional molten puddle and a third amount of total energy is input into said second trailing consumable interaction zone.

20. The method of claim 19, wherein said third amount of total energy is the same as the second amount of total energy.

21. The method of claim 19, wherein said second trailing consumable is positioned behind said leading consumable symmetrically with respect to said trailing consumable over a centerline of said leading consumable.

22. The method of claim 19, wherein each of said trailing consumable and second trailing consumable is positioned a distance D from said leading consumable, where D is in the range of 1.5 to 5 times the diameter of said leading consumable, and wherein said trailing consumable is positioned at a first angle off of the centerline of said leading consumable, and said second trailing consumable is positioned at a second angle off of said centerline, where said second angle is different from said first angle.

23. The method of claim 22, wherein at least one of said first and second angles is in the range of 10 to 75 degrees.

24. The method of claim 12, further comprising moving said trailing consumable with respect to said centerline during said advancing.

25. A cladding system, comprising:
a laser device which directs at least one laser beam at a surface of a workpiece to create a molten puddle on a surface of said workpiece;
at least one wire feeder device which advances a plurality of consumables into said molten puddle so that said consumables will be deposited on said workpiece;
a torch assembly which receives said plurality of consumables and directs said plurality of consumables to said molten puddle; and
a plurality of power supplies each of which outputs a heating current signal to said torch assembly, which directs said heating current signals to said plurality of consumables, respectively, to melt each of said consumables in said molten puddle;
wherein said torch assembly positions one of said plurality of consumables as a leading consumable and another of said consumables as a trailing consumable which trails behind said leading consumable, in a travel direction, while said consumables are advanced into said molten puddle during operation,
wherein each of said plurality of said consumables has a respective interaction zone in said molten puddle, and where a first amount of total energy from said at least one laser beam and the respective one of said heating current signals is input into said puddle at said interaction zone for said leading consumable and a second amount of total energy from said at least one laser beam and the respective one of said heating current signals is input into said puddle at said interaction zone for said trailing consumable, and
wherein said second amount of total energy is less than said first amount of total energy.
